(19) United States
(12) Patent Application Publication
(10) Pub. No.: US 2015/0245636 A1
(43) Pub. Date: Sep. 3, 2015

(54) Frozen Beverage Preparation Method and Device

(71) Applicant: Marshall Paul Forrester, JR., Mount Pleasant, SC (US)

(72) Inventor: Marshall Paul Forrester, JR., Mount Pleasant, SC (US)

(21) Appl. No.: 14/192,903

(22) Filed: Feb. 28, 2014

(51) Int. Cl. A23G 9/22

(52) U.S. Cl. CPC A23G 9/224

(57) ABSTRACT

A machine and method that creates an icy slurry or frozen preparation by cradling, rotating, and stirring a liquid within a container; possibly within a beverage's original, disposable container; and possibly with the assistance of internal rib structures or a disposable stirring blade attached to the cap threads of the original, disposable container.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the technical field of refrigeration. More particularly, the present invention is in the technical field of devices and methods of creating a frozen beverage.

2. Description of Related Prior Art

Various methods of producing icy drinks have been invented and patented. In May 1977, U.S. Pat. No. 4,022,031 was granted to Calim for a method and device to deliver a liquid mix through a freezing chamber. Refinements to this method include various techniques: the addition of pressure above atmospheric levels (U.S. Pat. No.4,401,449, Martin, August 1983), evaporation of the liquid within a vacuum (U.S. Pat. No.4,845,954, Johansson, July 1989), and a more efficient series of evaporators (U.S. Pat. No. 6,490,872, Beck, December 2002) or heat exchange mechanisms (U.S. Pat. Nos. 6,672,079, Ross, January 2004; 6,101,834, Ross, August 2000). Methods granted patents also include those which utilize properties of the liquid being frozen, such as heat exchange of liquids containing electrolytes (U.S. Pat. No. 4,907,415, Stewart, March 1990), and harvesting slurry using the buoyancy of growing ice crystals (U.S. Pat. No. 4,801,436, Connery, January 1989).

Patents have also been granted for methods of cooling drinks that do not rely on an icy slurry per se: freezing solid a portion of the beverage (U.S. Pat. No. 6,311,499, Broadbent, November 2001), forming ice around the outside of a bottle (U.S. Pat. No. 7,272,935, Wolf, September 2007), and a refined method for shaving ice (U.S. Pat. No. 7,340,905, An, March 2008).

Interest in increasingly convenient and economical methods for producing an icy slurry for consumption continues to draw interest from inventors—Patents were recently issued for a method to super-cool liquid at time of dispensing (U.S. Pat. No. 6,928,824, Hess, August 2005), super-cooled liquid dispensed in the door of a refrigerator (U.S. Pat. No. 7,856,832, Lim, December 2010), and a device and method of manual agitation with the assistance of inserted freezing devices (U.S. Pat. No. 8,151,577, Bucceri, April 2012).

The prior art relies upon machinery that, while novel or thorough, may not be economical or practical for an average household to purchase or utilize. Despite the fact that many machines and methods for producing icy slurries or frozen confections have been patented, such machines and methods still rely upon relatively expensive, complex machinery and/or circuitry; as well as augers, mixing blades and containers that must be removed and/or cleaned after every use (U.S. Pat. Nos. pertaining to icy slurry: 6,918,258, Cunha, July 2005; 6,625,993, Frank, September 2003; 5,095,710, Black, March 1992; 4,736,593, Williams, April 1988; 3,698,203, Stoelting, October 1972. U.S. Pat. Nos. pertaining to ice cream or frozen confection: 2011.0006079 McKay, January 2011; 5,823,675 Myerly, October 1998; 4,773,233 Kawasumi, September 1988; 4,429,549 Randolphi, February 1984; 3,988,902 Jacobs, November 1976).

Recent notable inventions included the option of removable containers, the contents of which are stirred with mixing blades attached to separate motorized lids (U.S. Pat. Nos. 6,510,704 Russell, January 2003; 4,716,822 O'Brien, January 1988). Such innovation still does not solve the problem of removal and cleaning of non-disposable containers, stirring blades, and/or augers after every use.

### SUMMARY OF THE PRESENT INVENTION

The present invention is a machine and method that creates an icy slurry or frozen confection by cradling and rotating a beverage or liquid within the beverage's original, commercial, disposable container (or other container as provided), and possibly with the assistance of a disposable cap/mixing blade assembly which attaches to the original container (or alternately, mixing blades or ribs built into and/or attached to containers as provided). The machine supplies no refrigeration in or of itself—the machine is designed to sit or attach within (or be ‘built-in’), and function within an average-sized freezer compartment of a consumer refrigerator.

### BRIEF DESCRIPTION OF THE DRAWINGS

FIG. 1 is a perspective view of a machine to rotate disposable or non-disposable beverage containers of the present invention;

FIG. 2 is a side view of the machine of FIG. 1;

FIG. 3 is a top view of the machine of FIG. 1;

FIG. 4 is a cross-section view of the cap fitting with attached auger of the present invention;

FIG. 5 is a cross-section view of the cap fitting with pressure relief mechanism of the present invention;

FIG. 6 is a side view of a disposable or non-disposable container with ribbed internal walls of the present invention.

### DETAILED DESCRIPTION OF THE INVENTION

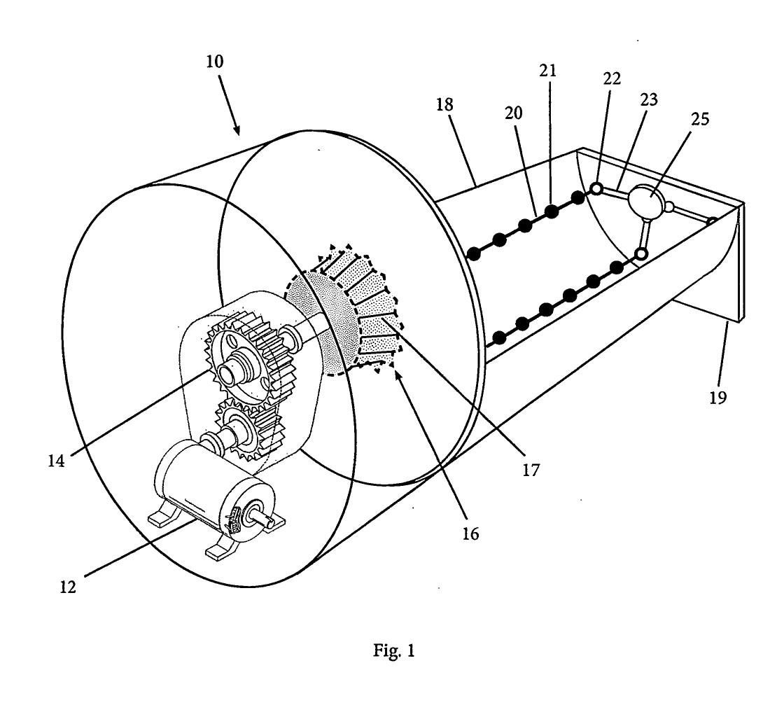

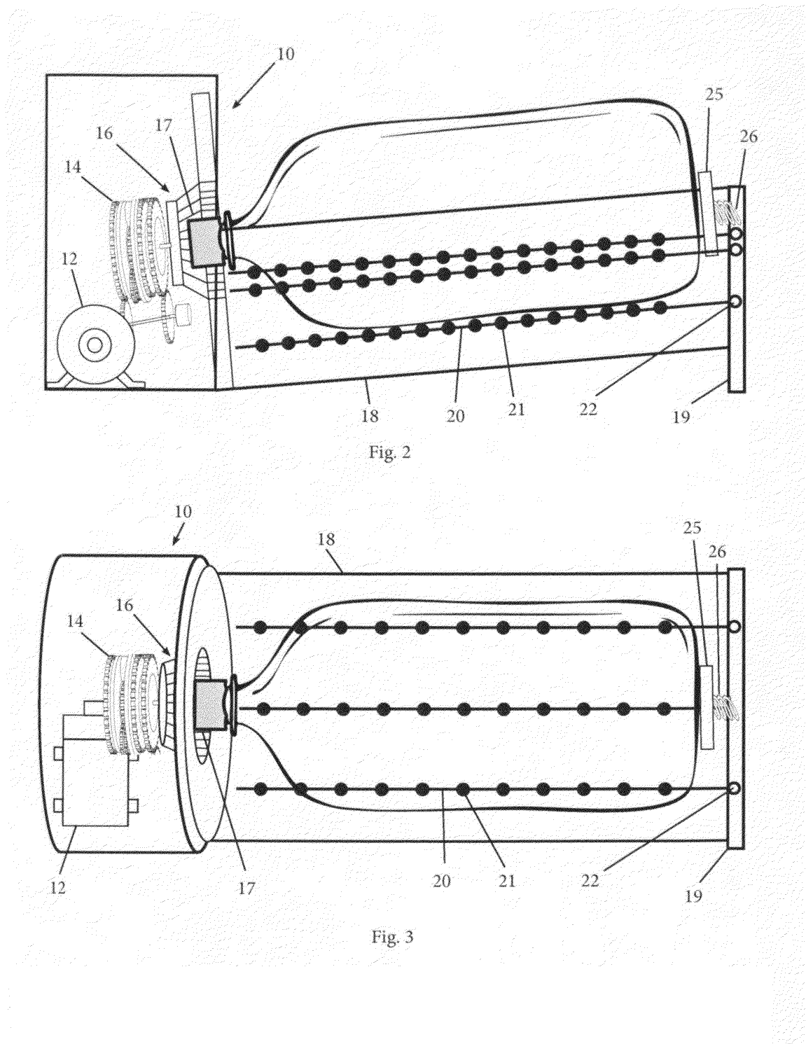

Referring now to the invention in more detail, in FIG. 1, FIG. 2, and FIG. 3, there is shown a machine 10 which has an electric motor 12 that drives a gear box 14. This gear box 14 is connected to and rotates a conical cap receiver 16 that contains splines 17. Connected to the machine is a cradle 18 which is in turn connected to and held by a support 19. Within the cradle 18 are multiple struts 20 to which in turn are attached multiple rollers 21. Each strut 20 terminates at the support 19 in a receiver 22, and each strut 20 may slide along a slot 23 that begins at the receiver 22. A disc 25 is attached to the support 19 by way of a spring 26.

In more detail, still referring to the invention in FIG. 1, FIG. 2, and FIG. 3, the invention shown creates an icy slurry by cradling and rotating a beverage within the beverage's own original, disposable container or other container as provided (“container” or “disposable container”). The container rests on the rollers 21 so that the cap of the container fits in the cap receiver 16. The disc 25, enabled by the spring 26, presses against the bottom of the container to ensure continued contact and sufficient friction between the cap of the container and the splines 17. The electric motor 12 turns the gear box 14 that is attached to and thus rotates the cap receiver 16. The splines 17 inside the cap receiver 16 grip the cap of the disposable container and rotate the cap while it is attached to and sealing the disposable container, therefore rotating the entire disposable container. The entire machine 10 is placed inside a consumer refrigerator freezer-compartment, the container spins on the rollers 21. While the beverage freezes, the spinning motion prevents the beverage from freezing into a solid mass. Instead, an icy slurry is created.

In further detail, still referring to the invention in FIG. 1, FIG. 2, and FIG. 3, the cradle 18 and struts 20 are designed to hold, at the largest, a typical full-sized commercial 2-litre plastic bottle. The connection of each strut 20 to the support 19 may be adjusted along each respective slot 23 so that containers of smaller diameter may be accommodated. The disc 25 is designed to extend by way of the spring 26 so that containers shorter than the cradle 18 may also be accommodated. The diameter of the cap receiver 16 tapers slightly in relation to the depth inside the cap receiver 16, so that both larger diameter and smaller diameter container caps may be accommodated. The flexibility of strut 20 positioning, disc 25 extension, and cap receiver 16 diameter is designed to allow the machine 10 to accommodate typical full-sized commercial 2-litre plastic bottles at the largest and typical individual-sized plastic bottles at the smallest. The height of the support 19 is designed to tilt the cradle 18 toward the cap receiver 16 so that as a container turns on the rollers 21 gravity may assist in keeping the container cap in full contact with the splines 17.

The invention as shown in FIG. 1, FIG. 2, and FIG. 3 will be constructed with molded or injected plastic, aluminum, steel and other available materials. The entire shell including the cradle 18 and support 19 will likely be constructed with molded plastic or other light but strong material. The moving parts will likely be constructed with a combination of plastic and metal as available. The gear box 14 will be constructed to a size and ratio so as to provide a container rotation speed best conducive to the freezing process.

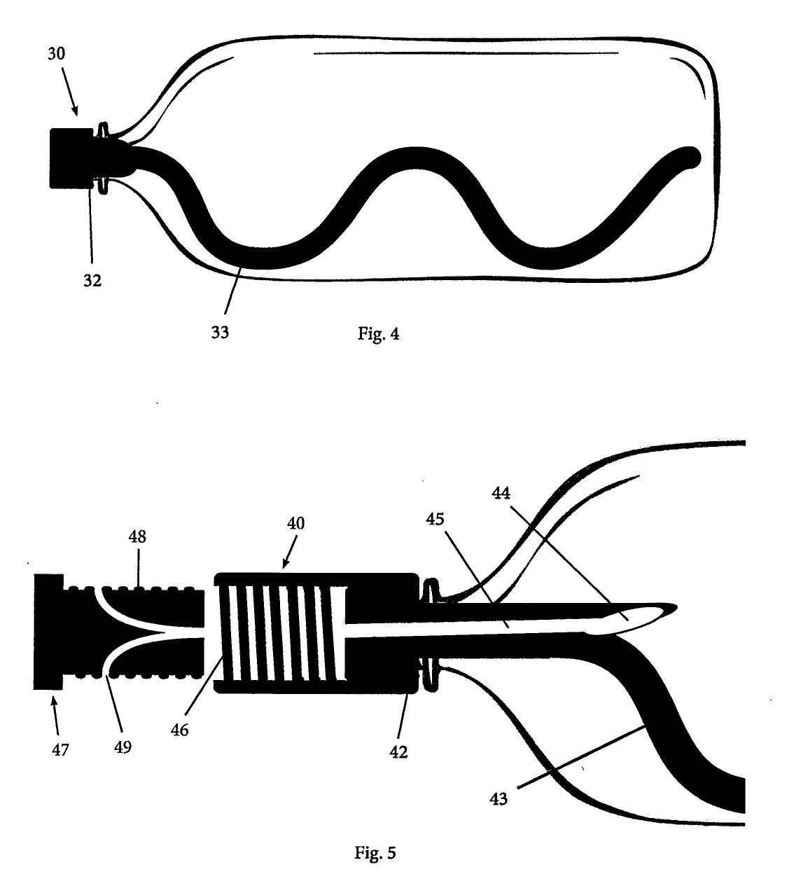

Referring now to the invention in FIG. 4, there is shown a cap assembly 30. The threads 32 within the cap portion of the assembly fit the standard threads found on the neck of commercial disposable plastic beverage containers. An auger 33 extends into the container. The entire cap assembly 30, including threads 32 and auger 33, consists of one piece of injection-molded plastic. Different sizes of the cap assembly 30 are manufactured to fit within large, medium, or individual-sized beverage containers. During the process of freezing a beverage into an icy slurry, the entire cap assembly 30 and attached container rotate in tandem. While rotating, the auger 33 enhances the evenness of the slurry mix by breaking apart any larger particles of ice that may develop. The entire cap assembly 30 is durable enough to be reused many times as desired, and yet inexpensive enough to be considered disposable.

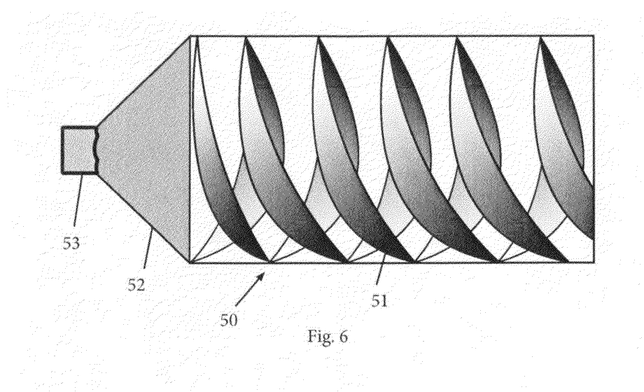

Referring now to the invention in FIG. 5, there is shown a cap assembly 40 with threads 42 and auger 43 that work in a manner similar to the like-named components found in the invention of FIG. 4. However, the present cap assembly 40 also includes a vent 44, channel 45, and cap threads 46. Also included in the invention in FIG. 5 is a plug 47 that fits within the cap assembly 40. The plug 47 includes plug threads 48 and exhaust ports 49. The plug threads 48 screw into the cap threads 46. When the plug 48 and the cap assembly 40 are joined together, the vent 44, channel 45, and exhaust 49 form one continuous duct. When the plug 47 is completely tightened into the cap assembly 40, the exhaust ports 49 are blocked by the walls of the cap assembly 40—thus, no gas or liquid may escape. Both the plug 47 and cap assembly 40 are formed from injection-molded plastic. When carbonated beverages freeze, carbon dioxide is released. If enclosed within a sealed container, the released gas results in increased pressure within the container. The invention in FIG. 5 is designed to safely release this accumulated pressure. When the plug 47 is partially unscrewed from the cap assembly 40, the exhaust ports 49 are exposed, allowing gas or liquid to pass through the continuous duct formed by the vent 44, channel 45, and exhaust 49; yet, without allowing the plug 47 or cap assembly to “explode” or be blown off by the accumulated carbon dioxide pressure.

Referring now to the invention in FIG. 6, there is shown a ribbed container 50. Formulated upon the interior walls of the container are a series of ribs 51. The container is sealed with a lid assembly 52, that includes an extension 53 in the shape of a beverage container lid. The lid assembly 52 and extension 53 are one piece, formed from injection-molded plastic. The ribbed container 50 and attached ribs 51 are one piece, formed from injection-molded plastic. This ribbed container 50 is designed to fit within the invention of FIG. 1 and freeze liquids that are not packaged in containers that easily fit within the cradle 18 of FIG. 1 (such as such as dairy-based, juice-based, or custom-mixed beverages). The internal rib 51 structures are designed to churn the contents during freezing so that an icy slurry, frozen confection, or smooth cream results. The extension 53 fits within the cap receiver 16 of FIG. 1 to accommodate the rotation of the entire container during freezing. The wide mouth of the lid assembly 52 is designed to allow spooning of the frozen beverage as desired. The entire ribbed container 50 is durable enough to be reused many times as desired, and yet inexpensive enough to be considered disposable.

The advantages of the present invention include, without limitation, the ability to create an icy slurry beverage or frozen confection both conveniently and economically. Machines for home use that create frozen beverages can be expensive and require extensive clean up. The present invention is convenient in that it may utilize a beverage's own disposable plastic container in which to create a frozen slurry, or other disposable or non-disposable containers as provided. The present invention is economical because it does not require the generation of internal refrigeration—it is designed to attach to or fit within and function within an average-sized freezer compartment of a consumer refrigerator.

In broad embodiment, the present invention is a machine and method that creates an icy slurry or frozen confection by cradling, rotating, and stirring a beverage or liquid—either within the original, disposable container or within other containers as provided. The machine may either sit within or attach to the wall of an average-sized freezer compartment of a consumer refrigerator. The machine may draw power from batteries, from an external power adapter, or alternately plug in to power available within the freezer compartment (i.e. standard icemaker power supply).

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The novel and non-obvious claims related to this invention are as follows:

1. A machine that sits within, or attaches to the inside of an average-sized freezer compartment of a consumer refrigerator; that cradles, rotates, and adapts to various sizes of, commercially available containers, disposable or otherwise; for the purpose of creating an icy slurry beverage or frozen food preparation.

2. A cap fitting, that seals various disposable beverage containers (either directly or by adapter), that has attached an auger that mechanically prevents the solid freezing of a slurry mixture during rotation of the container; and that may allow for accumulated pressure inside a beverage container to dissipate by partially unscrewing (but without completely unscrewing or removing) the plug fitting.

3. A custom-shaped disposable or durable container with ribbed structures on the internal walls that mechanically prevent the solid freezing of a frozen confection during rotation of the container.
